(19) United States
(12) Patent Application Publication
(10) Pub. No.: US 2010/0021347 A1
(43) Pub. Date: Jan. 28, 2010

(54) Detection Device Based on Surface Plasmon Resonance Effect

(76) Inventor: João Garcia Da Fonseca, Azambuja (PT)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/513,927

(22) PCT Filed: Nov. 8, 2007
(86) PCT No.: PCT/PT07/00047

§ 371 Date: Sep. 2, 2009

(30) Foreign Application Priority Data
Nov. 9, 2006 (PT) PT 103601

(51) Int. Cl. G01N 21/00

(52) U.S. Cl. 422/82.05

(57) ABSTRACT

The present invention describes a detection device based on the surface plasmon resonance effect, comprising: (1) a rotational microfluidic substrate (40) with channels (45), valves (50) and reservoirs (41,44) and at least one Detection Zone (42) wherein said Detection Zone comprises a Detection Surface (DS) built on top of a dif tractive thin electrically conductive layer, —(2) a system comprising a light emitter (20) and a light detector (30) capable of transducing the occurrence of events near the DS by exploiting the surface plasmon resonance effect in the diffractive conductive layer, —(3) a mechanism for controlling the rotation speed, duration and positioning of the rotational microfluidic substrate, in order to move a predefined liquid volume from an initial reservoir into a Detection Zone and finally into a final reservoir. The sensor described in the present invention enables the determination of the concentration of specific chemical and/or biological substances present at the DS or present in the fluid near the DS.

### TECHNICAL FIELD

The present invention relates to electro-optic sensors based on the Grating mode of the Surface Plasmon Resonance (SPR) effect. In particular, the invention relates to chemical and/or biological detection devices and processes that include the following elements: (1) a Rotational Fluidic Substrate (RFS) containing channels, valves and reservoirs, and at least one Detection Zone (DZ) wherein a Detection Surface (DS) is built on top of a diffractive thin conductive layer; (2) a group of light emission and detection capable of transducing the occurrence of events near the DS into by exploiting the surface plasmon resonance effect in the diffractive conductive layer; (3) a mechanism for controlling the rotation speed, duration and positioning of the rotational microfluidic substrate, in order to move a predefined liquid volume from an initial reservoir into a DZ under controlled flow conditions.

### Chemical/Biological Detection Devices

A Chemical/biological detection device is composed by three major elements: (A) one recognition element, capable of recognizing a specific chemical and/or biological substance; (B) one transducing mechanism, capable of converting the chemical/biological recognition events into quantitative information; (C) one fluidic mechanism, capable of controlling the flow of the fluid to be measured, from its initial reservoir into the recognition element.

### (A) Recognition Element

Recognition elements are based on the key-lock principle, and comprise molecular regions or combinations of the same capable of recognizing specific chemicals or biological substances. There are different ways to achieve this effect, namely: randomly or oriented enzymes, lectines or antibodies. The performance of this recognition element is dependent on several parameters, namely: (i) its sensitivity (defined by its detection limit); (ii) its specificity (defined by its degree of sensitivity for detecting other substances present in the same medium of the specific analyte to be detected; (iii) its stability over time. In the case of chemical/biological detection devices used in measurements of proteins or enzymes, the recognition elements usually consists in one layer of specific and oriented antibodies. The chemical/biological recognition element may be obtained using several different mechanisms, namely: (i) chemical adsorption to the surface; (ii) encapsulation on a polymeric matrix; (iii) covalent bonding to a solid substrate. Although the choice of the chemical/biological recognition element is beyond the scope of the present invention, the description presented above serves only has a framework overview of the most common possibilities for building this biosensor element.

### (B) Transducing Mechanism

There are several different methods capable of converting chemical/biological events into quantitative information that is then available for analysis and data treatment, namely electrochemical, vibratory, magnetic and optic transducers. The optical detection of the SPR effect is essentially a measurement technique of the refractive index close to an electrically conductive surface. The most significant difference of SPR detection compared to conventional refractometers relates to the measurement scale and detection process: in conventional techniques, all the fluid volume contributes to the optical response which results in a average measure of the refractive index; On the contrary, in the case of SPR detection, only the volume of the fluid close to a conducting surface is relevant. Moreover, in this later case, the measure corresponds to a weighted average of the refractive index with a decaying weight when moving apart from the conductive layer where the SPR effect occurs.

### SPR Effect

The SPR effect is an optical phenomenon that results from the local charge density oscillation in an interface between two media of differing dielectric properties. In particular, the SPR effect occurs at the interface between a dielectric medium and a metallic one (see reference 1). In this case, the surface plasmon wave is an electromagnetic wave with polarization TM (magnetic vector of the wave is perpendicular to the propagation direction and parallel to the interfacial plan). The SPR propagation constant β may be described by equation (1).

$$β = λ \sqrt{\frac{{ɛ}_{m} {ɛ}_{d}}{{ɛ}_{m} + {ɛ}_{d}}} \qquad ( 1 )$$

Where λ is the incident wavelength, ∈ₘ is the dielectric constant of the metal (∈ₘ=∈ₘᵣ+i∈ₘᵢ) and ∈_{d} is the dielectric constant of the dielectric medium. The SPR only occurs if ∈ₘᵣ<0 and |∈ₘ|<∈_{d}. In this case, the Surface Plasmon will propagate at the interface between the two media and will decrease exponentially from the interface to the bulk of each medium. On the other hand, the SPR effect is only detectable for metallic films with thicknesses in the range of tens to hundreds of nanometer In the case of a gold film, the SPR effect typically occurs with thicknesses between 25 nm and 150 nm).

Due to these facts and according to equation (1), the propagation constant β of the SPR is extremely sensitive to variations of the refractive index in the dielectric medium close to the interface. As a consequence, the SPR effect may be exploited for sensing applications, e.g. the immobilization of a certain biological material (protein, enzyme, etc.) close to the interface will result in a local variation (at the nanometer length scale) of the refractive index (since typically the refractive index of water-based solutions is around 1.33 and the refractive index of biological compounds is close to 1.54). This change on the refractive index induces a change on the propagation constant of the surface plasmon that may be detected with precision by optical means, as described in the following sections.

### SPR Configurations

There are three basic methods for detecting the SPR effect:

(i) Measuring the intensity of light reflected from the detection surface as a function of the light incidence angle. Typically, for a given wavelength, the SPR effect is clearly detected at a specific incidence angle where the reflection is minimal;
(ii) Measuring the intensity of light reflected from the detection surface as a function of the light wavelength. Typically, for a fixed incidence angle, the SPR effect is clearly detected at a specific light wavelength where the reflection is minimal;
(iii) by measuring the phase of light reflected from the detection surface as a function of the incidence angle or light wavelength. In this case, the SPR effect is clearly detected at a specific incidence angle or light wavelength where the light phase variation is maximal.

Different optical configurations may be used in order to properly detect the SPR effect (see reference 2), using typically an optical system that both creates surface plasmon (using an illumination element, e.g. a laser or a light emitting diode or any other appropriate radiation source) and also detects the SPR effect (using an optical measurement element, e.g. CCD, CMOS, photodiode, or any other appropriate element).

The SPR effect only occurs if the component of the vector of incident wave that is parallel to the interfacial plane is coincident with the component of surface plasmon wave. This specific condition will only exist if there is some coupling mechanism typically provided by (i) a prism; (ii) a wave-guide; (iii) a diffraction grating. The man of the art may rapidly understand these coupling techniques by reading technical literature, namely by reading reference 1.

### (C) Fluidic Mechanism

In order to complete the basic necessary functions of a biosensor one has to define the process for fluid management. Conventional fluidic mechanisms rely on the use of an external pumping device, connecting tubes, valves, detection zones and reservoirs. This approach is complex and expensive. In order to minimize the limitations associated to the conventional fluidic mechanism, different approaches have recently been proposed, mainly exploiting integration and miniaturization (see reference 3), namely: (i) pressure control; (ii) acoustic/piezoelectric control; (iii) electrokinetics; (iv) centrifugal control.

Fluid control by means of the centrifugal approach (see reference 4) presents several advantages when compared to the other competing technologies, mostly due to its simplicity and wide-range of application (e.g. in terms of sample volumes and flow rates). Thus, the centrifugal effect may be exploited at the microscopic scale in order to create conventional fluidic functions: e.g. triggering flow, aliquoting, mixing, filtering, reacting, and detecting. This fact is only possible at the microscopic scale, where surface forces assume an increasing dominance and gravity is mostly negligible, so the geometry, dimensions and surface tension of the fluid channels influence to a great extent the flow behaviour of the fluids. This scale effect arises as a consequence of an increasing surface to volume ratio of the fluid when confined to micro-architectures and the fact that molecules present in surfaces carry an extra amount of energy compared to those in bulk. Moreover, due to the weight of physical interactions at the microscopic scale, it is also possible to create passive valves for fluid management, which are acted controlling the substrate angular speed (see reference 5). This last aspect is particularly advantageous since it allows a great degree of simplification for the construction of fluidic devices.

The present invention considers the integration in the same substrate, of SPR detection(s) zone(s) based on the grating coupling with a thin metal layer (˜25 nm-150 nm) and channels, valves and reservoirs, enabling the construction of simple sensors for different applications in the chemical and/or biological fields.

The U.S. Pat. No. 5,994,150 and associated patents (patent applications US2001031503 and U.S. Pat. No. 6,653,152 and U.S. Pat. No. 6,277,653) describe a detection system that uses a rotating circular disc with multiple zones of detection. In this case, the disc does not contain any fluidic elements or detection chamber, and it also does not contain any information relating to surface modifications in order to engineer fluid management and optical detection using thin metal layers with immobilized molecular probes.

The patent application WO9721090 describes a detection system for chemical or biological elements, with detection areas in a rotating support. It also describes the use of centrifugal control for fluid management, combined with a mechanism capable of reading the existing information in a modified COMPACT DISC. Essentially, the above mentioned patent describes the fluidic control mechanisms and makes only reference to conventional detection methods, without reference to the SPR detection method.

U.S. Pat. No. 6,030,581 describes a system of fluid control based in modified COMPACT DISC reader, in which the different necessary functions are performed by the modified COMPACT DISC reader, in particular: (1) control of the position of specific areas (e.g. storage zones, detection zones, reaction zones); (2) fluid positioning; (3) fluid control between predefined zones (e.g. from storage reservoirs to detection zones); (4) optical detection of chemical reactions or immobilizations through the modified COMPACT DISC reader optical system. From its claims and description, this patent applies to systems with conventional optical detection processes, with no reference to SPR detection.

Patent JP2004117048 describes an SPR detection system in the prism configuration, using a rotating disc. There is no reference to any fluidic control mechanism.

The patent application WO03102559 describes an SPR detection system in the configuration of prism, using a rotating disc with an integrated system for fluidic control. This patent only describes an SPR system base don the prism configuration, and does not include any reference or description to the diffraction grating configuration. Moreover, the rotating element includes the prism geometry in the detection zones, so that the SPR surface is in an inner wall of the detection chamber and at least a part of the detection window stretches from the SPR surface to an outer surface of the disc.

This fact implies the production of geometrical arrangements on the rotating substrate that are difficult to accomplish. The existence of these geometrical prism-like arrangements limits the use of the rotating substratum for high rotation speeds, under which the uniformity of the rotating substratum is of most importance for the detection performance.

Two academic studies concerning the characterization of the SPR on disc substrates have been published in the past (see references 6 and 7). These studies mention only the study of the SPR effect in the gold-air interface, not mentioning any measurement or detection of any chemical or biological compound. These studies do not concern any fluid control by means of the centrifugal approach.

In summary,

(i) New fluidic control approaches (see reference 3) have been proposed in the recent past, with the main purpose of minimizing the limitations associated to the conventional fluidic control using external pumps. From these and due to its simplicity and high precision (see references 4 and 5), the centrifugal approach is considered to present great advantages when compared to the other fluid control approaches;
(ii) The SPR effect has been exploited in the recent past for new detection applications (see reference 2), and today there are a few commercial products based in the SPR effect with the prism configuration (e.g. the “SPReeta” from “Texas Instruments”, the Biacore equipment from “Biacore corporation”). Despite its performance comparable to the prism configuration (see reference 1), the grating coupling configurations is today somehow residual and still limited to academic studies, although there are already two commercial applications of this configuration (“HTS Biosystems” and “GWC Technologies”);
(iii) Currently, no commercial application or scientific study integrates both components of fluid control using the centrifugal approach and SPR detection based on the grating coupling.

The following publications are included here for reference:
1. Homola, J. Et al. Sensors and Actuators 54, 3-15 (1999);
2. Homola, J. Anal Bioanal Chem 377, 528-539 (2003);
3. ZOVAL, J V and MADOU M J., Proceedings of the IEEE (2004), 92, 140-153;
4. Duffy, D. C. et al. Anal. Chem. 71, 4669-4678 (1999);
5. Felton, M J, Anal. Chem. 75, 302A-306A (2003);
6. Fontana, E. Applied Optics 43, 79-87 (2004);
7. Chiu, K P et. al. Jap. J. Appl. Phys. Part 1 43, 4730-4735 (2004);
8. T. Brenner, et al. Lab on a Chip, 5(2):146-150 (2005)

### OBJECT OF THE INVENTION

From our work in the past, it became clear that it would be relevant to exploit the possibility of detecting the occurrence of chemical and/or biological events in specific microscopic structures using the following elements:

(a) the SPR detection principle based on the diffraction coupling, since this particular configuration presents several advantages when compared to the other possible SPR configurations. In particular, devices exploring the grating coupling configuration are much simpler and less expensive to produce when compared to the other SPR configurations. Moreover, the SPR detection based on the grating coupling may be further explored to achieve better performances then prism configurations. Although its analytical modeling presents additional complexity, the grating coupling enables the man of the art to play with parameters (not available in the prism configuration) adjustable to particular needs (e.g., by acting on the grating topography, conductive patterning, multilayer conductive/dielectric layering, etc. It is thus possible to build SPR sensors with properties unattainable in the prism configuration.
(b) the fluidic control system based on the centrifugal approach, and thus not requiring additional elements such has pumps, tubes and interconnects. This fact leads to low-cost, simple micro-fluidic systems of high performance and multiplexing capability.
(c) the substrate used for the detection integrating the different fluidic elements, such as reservoirs, inlets/outlets, channels, valves and at least one detection zones containing a detection surface built on a thin electrically conductive diffractive layer. This integration allows a great level of simplification of the fluidic substrate control, and consequently it allows for a great level of simplification in the final device use.

In a first aspect, the present invention incorporates an optical system of illumination and measurement, consisting of a radiation source and a detector of the reflected radiation, to detect events occurring in the proximity of Detection Surfaces. These latter include a conducting thin film deposited on a diffraction grating to allow for SPR determinations. The diffraction grating is defined in a solid substrate which also incorporates fluid management elements such as channels, valves and reservoirs. The angular speed of this substrate is controlled to direct different fluids from initial reservoirs to final reservoirs passing for, at least, one DS where the SPR phenomenon can be used for the detection of chemical and/or biological events.

In a second aspect, the present invention consists of an SPR sensor comprising (e) a Rotational Fluidic Substrate; (f) an optical system for emission and detection, consisting in a light emitter, a light detector, both used for the detection of specific events occurring close to a detection surface of a DZ built in the Rotational Fluidic Substrate; (g) with the DZ having a detection surface containing a thin conductive and diffractive layer enabling the detection of an SPR optical signal at the light detector, enabling the measurement of:

(i) the presence of a specific chemical or biological substance, and/or;
(ii) the occurrence of a specific chemical and/or biological event in a DZ of the Rotational Fluidic Substrate;

The positioning of the light emission and detection elements relative to the RFS is such that the light beam incident on the DZ contains at least one incident angle for which the optical coupling occurs at the conductive diffractive layer of the DS, and as a consequence, the SPR effect is observed.

This specific configuration depends on several properties and parameters, in particular:
The wavelength of the light incident at the DZ;
The refractive index, extinction coefficient, grating topography and thickness and metal or combination of metals used for the construction of the conductive layer;
The angles of incidence at the DZ;
The refractive index and coefficient of extinction of the fluid present in the DZ;

These parameters are usually predefined and fixed for a particular embodiment of the present invention, and so another term is essential for the SPR effect: the refractive index close to the DS of the DZ. This refractive index, integrated throughout a characteristic thickness that is also characteristic of the system (expressed typically by the penetration length of the Surface Plasmon wave, and solely depending on the above mentioned parameters), is directly measured by the SPR sensor through the measurement of the light incident on the detector. Depending on the type of SPR detector this can be accomplished by means of: light intensity measurement as a function of the incident angle; light intensity measurement as a function of the wavelength, or light intensity as a function of the light relative phase).

In this sense and settled all the parameters, it is possible to: (i) Measure the evolution of the light pattern in the SPR sensor; (ii) From this measure, obtain quantitative information on the change of the refractive index close to the DS; (iii) from this, quantify the immobilization at the DS of a particular chemical/biological compound, or further determine the chemical and/or biological reaction of two particular compounds close to the DS.

### BRIEF DESCRIPTION OF THE DRAWINGS

FIG. 1A is a schematic top view of an SPR sensor according to the prior art, with the representation of the external elements for fluidic control.

FIG. 1B is a schematic vertical cross-section view of a SPR sensor according to the prior art, without the representation of the external elements of fluidic control.

FIGS. 2A and 2B show, respectively, the top and vertical cross-section schematic views of a SPR sensor according to the present invention.

FIGS. 3A, 3B and 3C illustrate the simplified diagrams of the position of the fluid front as a function of the substrate rotational velocity, for the SPR sensor represented in the FIGS. 2A and 2B.

FIG. 4 shows a schematic top view of the RFS of an SPR sensor according to the present invention, containing three fluids and a single DZ;

FIG. 5A shows a schematic top view of the RFS of an SPR sensor according to the present invention, wherein the surface tension (of the reservoirs, valves and DZ walls) is controlled in such a way so that the device enables the fluid to return? after stopping the RFS.

FIG. 5B illustrates the simplified diagram of the fluid front radial position as a function of the rotational velocity, for the sensor of SPR represented in the FIG. 5A.

FIG. 6 shows a schematic top view of the RFS of an SPR sensor according to the present invention, wherein the geometrical parameters and the surface tension of the fluidic elements (reservoirs, valves and DZ) are controlled in such a way so that the device enables the conditional choice of one of two fluids for the SPR detection.

FIG. 7 shows a schematic top view of the RFS of an SPR sensor according to the present invention, wherein the geometrical parameters and the surface tension of the fluidic elements (reservoirs, valves and DZ) are controlled in such a way so that the device enables the conditional choice of one of two DZ for the SPR detection.

FIG. 8 shows a schematic top view of the RFS of an SPR sensor according to the present invention, wherein auxiliary detection elements enable the measurement with precision of the temperature close to the DZ.

FIG. 9 shows a schematic top view of the RFS of an SPR sensor according to the present invention, wherein the geometrical dimensions of the different fluidic elements (reservoirs, valves and DZ) are kept constant and only their surface tension is controlled, so that the sensor behaves in a similar way as described in FIG. 2A (not described?).

FIG. 10 shows a schematic vertical cross-section view of an SPR sensor according to the present invention, wherein the SPR detection is based on the measurement of the light intensity as a function of the wavelength.

FIG. 11 shows a schematic vertical cross-section view of an SPR sensor according to the present invention, wherein the SPR detection is based on the phase detection.

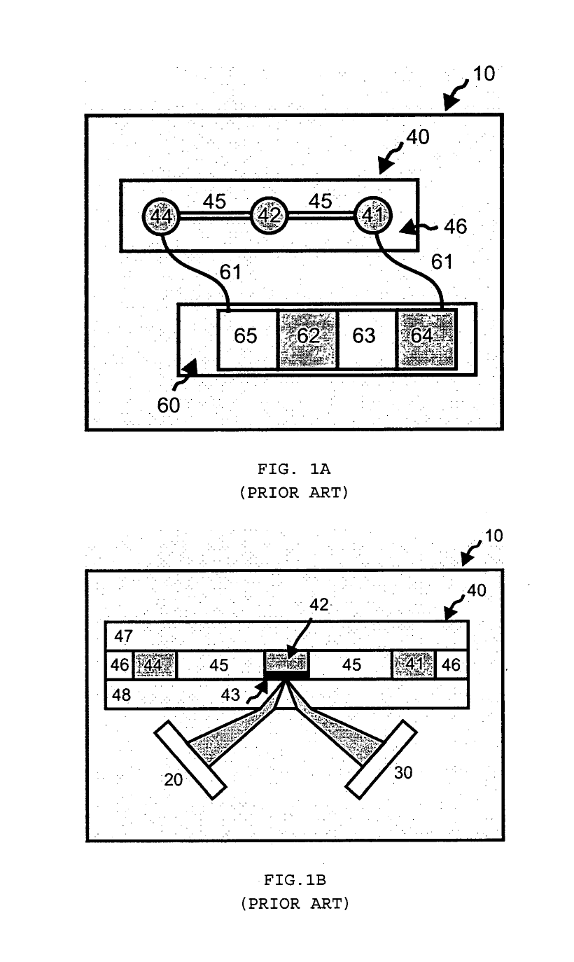

FIG. 1A is a schematic top view of an SPR sensor according to the prior art. A group of external elements for fluid control 60, consisting of tubes 61, a pumping device 62, fluid reservoirs 63 and a selection valve 64 are used in order to control the fluid into a fluidic substrate 40. This fluidic substrate consists in initial reservoirs 41, connected to a DZ 42 and finally to a final reservoir 45 44 through channels 45. The geometric parameters of the different fluidic elements are defined by confinement spacers 46.

FIG. 1B is a schematic vertical view of a sensor of SPR according to the prior art, without the representation of the external elements for fluidic control. The light emitter 20 emits a convergent beam incident at the DS 43 of the DZ 42, with the DS 42? being confined by the cover 43? and the fluidic substrate base 47. The DS 43 consists of a conductive diffractive grating in order to allow for the optical coupling and the occurrence of the SPR effect. The light reflected from the DS is incident on the light detector 30 in order to allow the quantitative analysis of the SPR effect. Since the DS 43 consists of a diffractive conductive layer, the light detector may be placed at different specific angles, as long as it is coincident to one of the diffraction orders. Alternatively to the indicated representation, the SPR sensor may be used with the fluidic substrate rotated 180° around the horizontal axis, in such a way that the radiation passes from the cover 47 into the DZ 42. The best choice of the entrance side of the light (either from the cover 47 or from the support 48) depends on the materials refractive index and the properties and thickness of the diffractive conductive layer used for the DS 42.

### DETAILED DESCRIPTION OF THE INVENTION

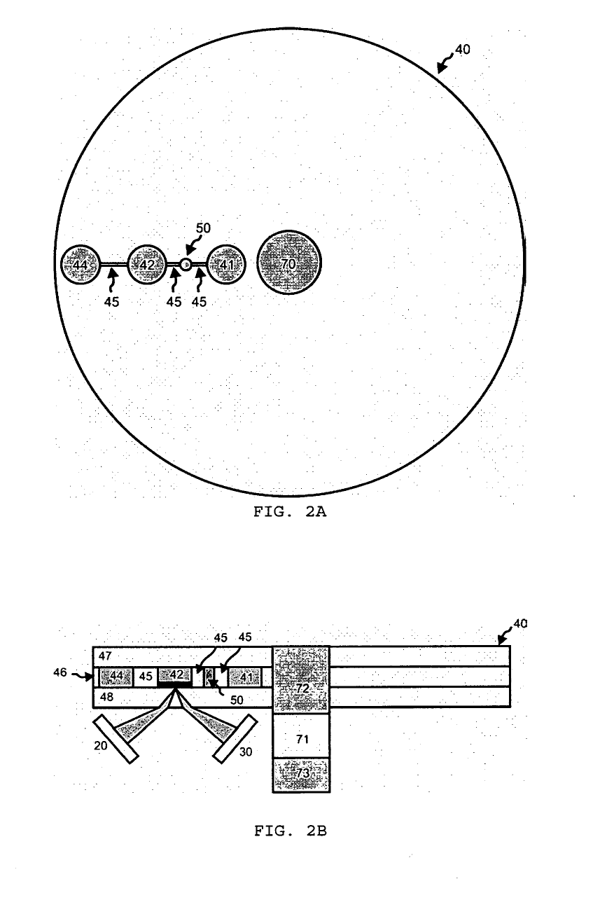

In a first aspect, the present invention includes an optical system consisting of a light emitter 20 and a light detector 30, used in a configuration that allows detecting chemical and/or biological events that occur in the proximity of SD 43. The SD 43 includes a thin conductive and diffractive layer, which is included in a RFS 40, that contains itself channels 45, valves 50, initial reservoirs 41 and final reservoirs 44. The rotational velocity of the RFS 40 is mechanically imparted by a rotational mechanism 70, that includes a motor 71 and a controller 72, and is explored to control the flow of different fluids from their initial reservoirs 41 to their final reservoirs 44, passing by, at least one DZ, 42 that contains a DS 43. Due to the fact that the DS 43 includes a thin conductive and diffractive layer, it allows the use of the SPR phenomenon for the detection of chemical and/or biological events. FIG. 2A shows a schematic top view of a SPR sensor according to the present invention. The RFS 40 contains an initial reservoir 41 that is connected to the DZ 42 by a channel 33. A valve 50 is placed between the initial reservoir 41 and DZ 42 in order to prevent fluid flow at rotational velocities below a certain threshold. FIG. 2B shows the corresponding vertical cross section schematic view of a SPR sensor according to the present invention. The RFS 40 is delimited by a top substrate 47 and a support substrate 48 and contains an initial reservoir 41 connected to a DZ 42 and from this to a final reservoir 44, by channels 45. The geometrical arrangements of the different elements of the RFS 40 are defined by confinement spacers 46, or alternatively engraved in either the top or support substrate). The rotational quantities (position, displacement, velocity and acceleration) of the RFS 40 are controlled by a rotational mechanism 70 that includes a motor 71 and a controller 72. The light emitter 20 irradiates a convergent beam that is incident at the DS 43 of the DZ 42. The DS 43 includes a conductive diffraction grating in order to allow for the optical coupling and hence the occurrence of the SPR effect. The light reflected from the DS 43 is captured by the light detector 30 allowing for quantitative analysis of the SPR effect. Since the DS 43 contains a metallic surface that also behaves as a diffraction grating, then the light detector 30 may be placed at different positions and angles, as long as these are coincident to one of the available diffraction orders. In an alternative to the indicated configuration, the SPR sensor may be used with the fluidic substrate rotated by 180° around the horizontal axis, in such a way that the radiation passes from the top substrate 47 to the DZ 42. The best choice of the entrance side of the light (either from the top substrate 47 or from the support substrate 48) depends on the materials refractive index and also on the properties and thickness of the diffractive conductive layer used for the DS 43.

Let us note here that the mentioned elements of the RFS 40 are independently described with respect to their function and they are not necessarily independent parts or made of different materials. In fact, the RFS described in FIGS. 2A and 2B may well be built in a single material or block, except for the DS 43 that includes a conductive diffractive thin layer. Furthermore, the RFS 40 is not necessarily of disc shape and may well be of any other shape, provided that it is able to rotate along a specific and predefined axis.

In a second aspect, the present invention consists in a configuration of the sensor of SPR 10, comprising a RFS 40 and an optical system containing a light emitter 20 and a light detector 30, in order to obtain in the light detector 30 an optical SPR signal that (i) indicates the presence of a specific compound or substance and/or (ii) indicates the occurrence of a particular chemical and/or biological event in the DZ 42 of the RFS 40.

The system described in the present invention contains different elements, in accordance with the FIGS. 2A and 2B: (a) a light emitter 20; (b) a RFS 40; (c) rotational mechanism 70 that includes an engine 71 and a controller 72 and a rotating support 73; (d) a light detector 30. In the following sections, we describe in detail each one of these different elements and we also show how to combine the functionalities of each of these elements in an innovative and advantageous form. The light emitter 20 is composed of an element capable of emitting radiation with a stable and well defined emission spectrum. In the case of a sensor of SPR 10 in the detection configuration of light intensity as a function of incidence angle, it is more advantageous to use a light emitter 20 consisting in a laser or laser diode, in such a way that the emission spectrum only contains a narrow wavelength band. In this case, the SPR effect may be observed by a strong variation of reflected light intensity (reflected from the DS r42) for a small variation of angles of incidence. Or alternatively, the light emitter 20 may consist in a LED connected to a radiation filter behaving like a bandwidth filter in terms of wavelength. In this case, it is possible to eliminate (meaning that it will not reach the DS 42 and/or the light detector 30) most of the emitted spectrum, except for a narrow wavelength band. This last characteristic of the light emitter 20 may in some cases be considered preferential, since it minimizes part of the noise associated to light coherency and diffractive interference. The light emitted for light emitter 20 is incident at the DS 43 of the DZ 42 of the RFS 40, and this light, transmitted or reflected in one of the diffracted orders (order 0, order +/−1, etc) is captured by the light detector 30.

The RFS 40, according to the description of FIGS. 2A and 2B contains all the elements necessary for: (a) storing fluids at their initial reservoirs 41 and final reservoirs 44; (b) fluid flow along the channels 45 to and/or through the DZ 42; (c) controlling fluid flow using valves 50. The DZ 42 contains a DS 43 that includes a thin conductive and diffractive layer. In order to assure that the SPR effect occurs it is necessary to have the grating period in the same order of magnitude as the light wavelength λ, typically 250 nm<λ<2500 nm and preferably 320 nm<λ<1600 nm. It is further necessary to properly adjust the grating height (GH) of the DS 43 so that the surface plasmon occurs, typically 10 nm <GH<500 nm and preferably 30nm<GH<200 nm. The man of the art is able to tune these two last parameters of the DS 43 in order to maximize the SPR sensor 10 performance due to the known dependency of their optimal values as a function of the light wavelength and material properties of the fluid and DS 43.

The relative position and angle of the emitter 20 with respect to RFS 40 is chosen in such a way that incident beam at the DZ 42 contains, at least, an angle of incidence for which there is an optical coupling in the conducting layer, resulting in the SPR effect. This configuration depends on different properties, and in particular of the following parameters:
The wavelength of the light incident at the DZ 42;
The refractive index, extinction coefficient, grating period, grating height and thickness of the conductive layer;
The angles of incidence at the DZ 42;
The refractive index and coefficient of extinction of the fluid present in the DZ 42;

These parameters are usually predefined and fixed for a particular embodiment of the present invention, and so another term is essential for the SPR effect: the refractive index close to the DS of the DZ. This refractive index, integrated throughout a characteristic thickness that is also characteristic of the system (expressed typically by the penetration length of the Surface Plasmon wave, and solely depending on the above mentioned parameters), is directly measured by the SPR sensor through the measurement of the light incident on the detector. Depending on the type of SPR detector this can be accomplished by means of: light intensity measurement as a function of the incident angle; light intensity measurement as a function of the wavelength, or light intensity as a function of the light relative phase).

In this sense and settled all the parameters, it is possible to: (i) Measure the evolution of the light pattern in the SPR sensor; (ii) From this measure, obtain quantitative information on the change of the refractive index close to the DS; (iii) from this, quantify the immobilization at the DS of a particular chemical/biological compound, or further determine the chemical and/or biological reaction of two particular substances close to the DS 42.

The rotation of the RFS 40 containing the DZ 42 is controlled in speed, acceleration and position, through a rotational mechanism 70 that includes an engine 71 and a controller 72 and a rotating support 73. The control of engine 71 may be carried through electric impulses of amplitude and duration defined by the controller 72. The rotational velocity necessary to induce flow of a liquid column delimited at radial positions r1 and r2 can be estimated balancing the pressure exerted at the meniscus due to centrifugal effect with pressure due to surface tension, as (2):

$${ω}_{c} = 2 \sqrt{\frac{γ cos θ}{ρ R Δ {Rd}_{H}}} \qquad ( 2 )$$

where θ is the contact angle between the fluid and RFS surface, R=(r1+r2)/2 is the average radial position of the fluid column, ΔR=r2−r1 is the fluid column length, ρ is the fluid density and d_{H} the hydraulic diameter of the channels.

The existence of the valve 50 situated between the initial reservoir 41 and DZ 42, represents an energy barrier that hinders fluid flow at rest (by capillarity), as long as the surface properties of the channels 45 and valve 40 are properly defined. For example, in the case of aqueous fluid flow, if the channels 45 and the valve 50 are of hydrophilic nature, then a rapid expansion of the channel hydraulic diameter 45 into the valve 50 represents an additional energy barrier that will hinder the fluid to advance. Moreover, if the materials of the RFS 40 are all hydrophobic it is also possible of obtain the same valve effect with a sudden constriction of the channels 45 hydraulic diameter. In all these cases, it is possible to obtain the desired passive valve effect by properly choosing the dimensional and geometric properties of each element.

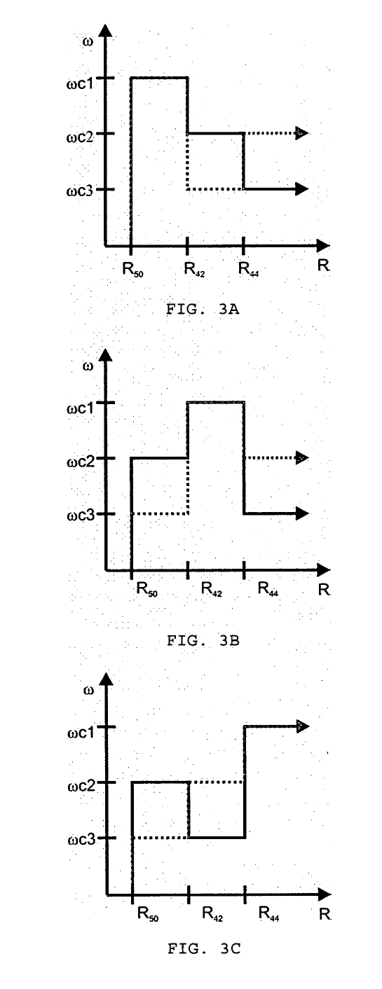

FIG. 3A shows a diagram of fluid front radial position as a function of the rotation velocity of the RFS 40 previously described in FIG. 2A. Given the geometric and of surface tension properties of initial reservoir 41, channels 45 and valve 50, the fluid spontaneously fill (by capillary) the channel connecting the initial reservoir 41 to the valve 50. Due to the radial configuration of the different elements of the RFS 40, the radial position of the fluid front (meniscus) (as a function of the rotational velocity ω) in the RFS 40 represents a critical threshold given by the critical velocity ω_{c} which the fluid front moves from the valve 50 to the DZ 42 with a linear velocity given, in a first analysis, by the equation (3):

$$v = \frac{ρ {ω}^{2} R}{2 η} {A}^{2} \qquad ( 3 )$$

where ρ and η are the density and viscosity of the fluid, respectively, R is the average radius of the fluid column (R=(r1+r2)/2) and A is a characteristic dimension of the channel 45 cross-section.

### First Example

Let us consider as a first example the case where the sum of the total volumes for the channels 45, valve 50 and DZ 42 is smaller than the volume of initial reservoir 41. The initial reservoir 41, the valve 50, the DZ 42 and the final reservoir 44 are hydrophobic and the channels 45 are hydrophilic.

The system preferably operated in a regime with small angular accelerations. High angular accelerations may lead to disruption of the fluid column and this jeopardizes the desired flow behaviour and hence is considered an unfavourable scenario of the present invention.

With the above-mentioned configuration, the system presents three barriers to the advancement of the fluid front (meniscus) as a function of the rotational velocity at (i) the entrance of valve 50; (ii) the entrance of DZ 42 and (iii) the entrance of final reservoir 44. The value of each one of these critical rotational velocities may also be adjusted through (iv) the position of each of these elements with respect to the initial reservoir 41 and (v) by controlling the dimension and the hydraulic diameter of channels 45. In this specific case, illustrated in more detail by the FIGS. 2A and 2B, there are six different possibilities for controlling the fluid flow. These possibilities are illustrated in FIGS. 3A, 3B and 3C.

FIGS. 3A, 3B and 3C illustrate the simplified diagrams of the position of the fluid front as a function of the rotational velocity, for the SPR sensor represented in FIGS. 2A and 2B. These figures demonstrate the possible critical rotational velocities necessary for controlling the sequential flow of the fluid from the initial reservoir 41, through valve 50 to the DZ 42 and finally to the final reservoir 44. In this particular case, the man of the art may choose one of these six regimes by acting on the positions and geometrical dimensions of the different elements of the RFS 40.

FIG. 3A illustrates the cases where the main barrier to fluid flow is present at the entrance of valve 50. For example, considering r₅₀=15 mm and d_{H50}=0.1 mm, we may have in relative terms: r₅₀=1, r₄₂=2, r₄₄=3 e d_{H50}=d_{H42}=d_{H44}=1 (full line) and r₅₀=1, r₄₂=2, r₄₄=3 and d_{H50}=d_{H42}=1, d_{H44}=0.3 (dashed line).

FIG. 3B demonstrates the cases where the main barrier to fluid flow is present at the entrance of the DZ 42. For example, considering r₅₀=15 mm and d_{H50}=0.1 mm, we may have in relative terms r₅₀=1, r₄₂=1.75, r₄₄=2.5 and d_{H50}=d_{H44}=1, d_{H42}=0.15 (full line) and r₅₀=1, r₄₂=1.75, r₄₄=2.5 and d_{H50}=1, d_{H42}=d_{H44}=0.15 (dashed line).

FIG. 3C demonstrates the cases where the main barrier to fluid flow is present at the entrance of the final reservoir 44. For example, considering r₅₀=15 mm and d_{H50}=0.1 mm, we may have in relative terms, r₅₀=1, r₄₂=1.75, r₄₄=2.5 and d_{H50}=d_{H44}=1, d_{H42}=0.15 (full line) and r₅₀=1, r₄₂=1.75, r₄₄=2.5 and d_{H50}=1, d_{H42}=d_{H44}=0.15 (dashed line).

Let us notice that the system described in this example only follows the model described by equation (2) if the atmospheric pressure is acting on both extremities of the fluid column. This may be achieved by leaving the initial reservoir 41 and the final reservoir 44 open to the air (e.g. by using an additional valve), or (in some case preferably) by connecting the initial reservoir 41 to the final reservoir 44 with an additional channel to allow for pressure equilibrium 49. In the case where no pressure balance exists, the system will have an additional contribution that will result in an increase of the critical rotational velocities due to the pressure drop at the initial reservoir 41 when the fluid starts to flow. This last fact may imply that, in some cases, the fluid tends to move back to the initial reservoir 41 when the RFS 40 is stopped after being rotated. Knowing this fact, this last configuration may also be explored according to further examples of the present invention.

In reality, the behaviour of the system described in FIGS. 2A and 2B is strongly dependent on the radius of the fluid fronts or menisci (starting radius r1 and final radius r2) in accordance with equation (2), so the volumes of each element of the RFS 40 must be properly defined by the man of the art in order to maximize the system performance and according to the choice of SPR detector configuration and type. Thus, we now describe in more detail some other specific examples of the present invention: (i) if the hydraulic diameter of the channels 45 is set constant, with the radial positions of the initial reservoir 41 and of the DZ 42 set r₄₁=20 mm r₄₁=40 mm, respectively, and if the distance from the DZ 42 to the initial reservoir 41 is twice the distance between the reservoir 41 and the valve 50, then in accordance with the equation (2) the second critical rotational velocity ω_{c2} is 65% the value of the first critical rotational velocity ω_{c1}; (ii) in the same conditions, if the hydraulic diameter of the channels 45 is set constant, and the distance from the DZ 42 to the initial reservoir 41 is the triple of the distance between the reservoir 41 and the valve 50, then the second critical rotational velocity ω_{c2} is 51% the value of the first critical rotational velocity. So, if the rotational velocity of the RFS 40 is kept constant and higher than ω_{c1} the fluid will pass from the initial reservoir 41 to final reservoir 44 without interruption until this later reservoir is full. From a practical perspective, this case may not be the most favourable configuration for the SPR sensor 10, since it may be advantageous that the fluid stays at the DZ 42 for a certain incubation period so that the necessary chemical and/or biological events occur. (iii) If now one considers a hydraulic diameter of channels 45 connecting the DZ 42 to the final reservoir 44 that is 50% of the hydraulic diameter of the remaining channels, for the same radial positions of the elements of RFS 40, the critical rotational velocity wc3 will be, in accordance with the equation (2), about 141% higher to ω_{c1}. In this last case the system presents two well definite thresholds, illustrated in FIG. 3B. It is then possible to adjust the time that the fluid stays at the DZ 42.

Let us now consider that the system contains, beyond the elements already mentioned, a light emitter 20 built in such a way that it focus a light beam in the DZ 42, and that the light beam reflected from the DS 43 is captured at the light detector 30, according to FIG. 2B. Typically the incident light is monochromatic so that the SPR effect is clearly observed and measured. In the construction of the SPR sensor 10 in accordance with the present invention, the man of the art may choose the light wavelength in accordance with the specifications of the sensor (in particular, the angle of incidence, the properties and thickness of the conducting layer) and obeying the model described in equation (1). Typically, the light wavelength λ is in the visible or infrared spectrum since wavelengths λ<365 nm (higher energies) may lead to breaking of chemical bonds of the fluid molecules or the DS 43 molecules. It is also typically preferable to have A superior to the near-infrared (λ<1100 nm) in order to have the light detector 30 made from low cost and high resolution sensors.

The novelty of the present invention consists of a device comprising: (i) a RFS 40 with initial reservoir 41, final reservoir 44, channels 45, and at least, one DZ 42 containing a DS 43 that includes a diffraction grating allowing for SPR detection; (ii) a set of light emitter 20 and light detector 30 arranged in such a way that the light beam is incident at the DZ 42 of the RFS 40 in a range of incident angles where the SPR effect occurs and reflected to the detector (iii) a rotational mechanism 70 that includes a motor 71 and a controller 72 and a rotating support 73, built and used in order to accomplish the following sequence of events:

### (1) Initial Positioning

The RFS 40 is rotated by the rotational mechanism 70 until reaching a predefined position where the light emitter 20 illuminates the DS 43 of the DZ 42. This positioning is performed at sufficiently slow rotational velocities so that the fluid does not move from its position at the initial reservoir 41. For that, the positioning must obey the model described by equation (2).

### (2) Initial Measurement.

The light detector 30 detects the light coming from the DS 43 of the DZ 42 and a reference signal is measured. This reference signal corresponds, for example, to the DS 43 comprising a specific antibody of a certain substance to be measured.

(3) Displacement of the Fluid from the Initial Reservoir.

The RFS 40 is rotated at a sufficiently high rotational velocity in order to break the energy barrier existing between the channel 45 and the valve 50, according to the model described by equation (2). In this case, the fluid is displaced from the initial reservoir 41 to the DZ 42. This displacement of the fluid can allow the occurrence of the desired chemical and/or biological event (e.g. if the DS 43 comprises a specific antibody of a certain substance to be measured, and if this substance is present in the fluid, then certain amount of the substance will be captured at the DS 43). It could be convenient that the fluid remains in DZ 42 during a period of time sufficiently long so that the desired the chemical or biological events occur in a significant level (incubation period). The optimization of the SPR sensor 10 performance depends on the type of substance to be detected, on its concentration in the fluid and also on the properties of the DZ 42 (e.g. geometry and dimensions). This optimization however is beyond the scope of the present invention.

(4) Fluid Displacement from the DZ 42.

After the desired occurrence of the chemical and/or biological events that are subject to detection, the RFS 40 is controlled by the rotational mechanism 70, in order to move the fluid from the DZ 42 to the final reservoir 44. The rotational velocity of the RFS 40 in controlled in such a way that the totality of the fluid is displaced from the DZ 42. On the other hand, the final reservoir 44 must be built with enough volume that all the fluid can be evacuated from the DZ 42.

### (5) Final Positioning.

The RFS 40 is rotated by the rotational mechanism 70 until it reaches a position where the light emitter 20 illuminates the DS 43 of the DZ 42 coinciding with the position of the initial measurement. The rotational mechanism 70 must be sufficiently precise in order to have a negligible positioning error (with respect to the initial SPR signal measure). This aspect is particularly important for the final behaviour of the SPR sensor 10, since it is only possible to establish a precise detection if the initial and final measurements are carried over the same surface or over surfaces with identical properties.

### (6) Final Measurement

The light detector 30 captures the light reflected from the DS 43 of the DZ 42 and a final measure signal is obtained. This signal corresponds, for example, to the DS 43 comprising a specific antibody of a certain substance that is to be measured with a specific concentration of these chemical and/or biological substances captured by the antibodies.

### (7) Concentration Determination

The difference between the final measurement and the initial measurement allows, after having a relationship previously established by calibration, to determine the concentration in the surface of the chemical and/or biological element that has been captured at the surface. This surface concentration may then be extrapolated to a concentration in the fluid.

The determination carried out by the SPR sensor 10 consists, in a first accomplishment, on the analysis of the intensity of the zero order diffraction optical signal reflected from the conducting diffractive surface of DS 43 as a function of the angle of incidence. Other accomplishments could be considered with advantage, namely, if the light detector 30 is placed in order to measure the intensity of the first order diffraction optical signal, or higher diffraction orders.

### Second Example

The previous example demonstrates that the present invention may be used to build and operate a SPR sensor 10 that does not require the use of external pumping or fluid control elements. In most practical cases, the use of the SPR sensor 10 for quantitative detection of chemical and/or biological events occurring at the DS 43 requires the use of different fluids flowing in and out of the DZ 42 in a sequential manner. These different fluids may be required for different functions (e.g. surface cleaning, fluid mixture, use of a secondary antibody, etc.). On the other hand, the process described in the first example implies a measure of the SPR effect in a dry surface right after fluid has passed the DZ 42 containing the DS 43. This may be difficult to accomplish in some cases and it may yield high experimental errors (e.g. if the DS 43 is highly hydrophilic then the complete removal of an aqueous fluid may be difficult to achieve).

Based on the principles already described, and attending to the flow mechanisms described by equation (2) it is possible to circumvent the above cited limitations through other accomplishments, in which the flow of multiple fluids is sequentially controlled.

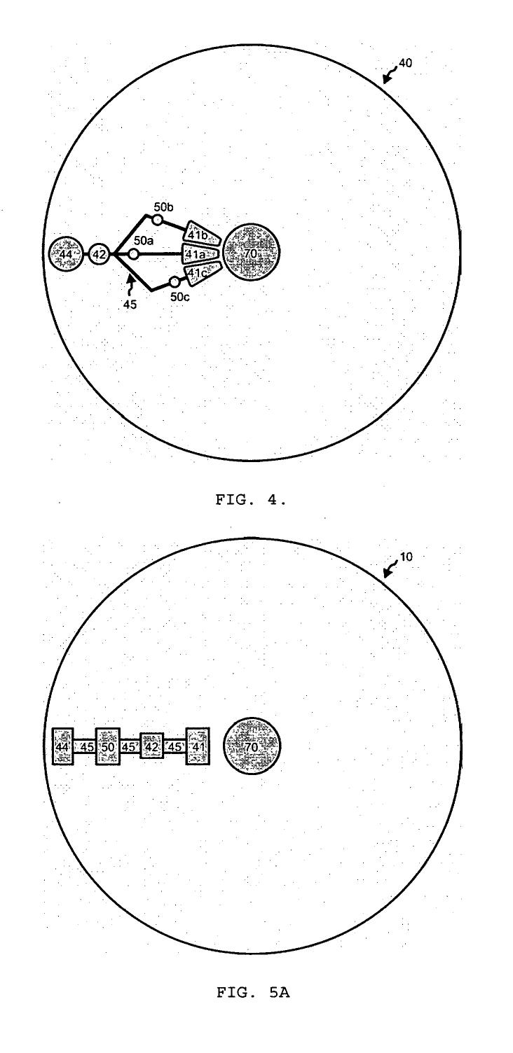

FIG. 4 shows a schematic top view of the RFS 40 of an SPR sensor 10 according to the present invention, containing three fluids and a single DZ 42. The RFS 40 includes three initial reservoirs 41a, 41b and 41c, all situated at the same radial position r₄₁. In this example we consider that all the channels 45 have the same hydraulic diameter and that the surface tension is kept uniform in all the RFS 40. Due to the dimensions and surface tension values of the RFS 40 elements, the valves 50a, 50b and 50c represent energy barriers for the fluid flow (in accordance with the previous representation, the system is now in the regime described by FIG. 3A). The initial reservoirs are connected by the channels 45 to their respective valves 50a, 50b and 50c, that are then connected by a common channel to the DZ 42 and finally to a single final reservoir 44. By construction, the radial positions r₅₀ₐ, r_{50b} and r_{50c} of the valves obey the relation r₅₀ₐ>r_{50b}>r_{50c}. So, in accordance to equation (2), there are three critical rotational velocity thresholds ω_{ca}, ω_{cb} and ω_{cc} that define the necessary rotational velocities for moving the fluids a, b and c from their respective reservoirs to the DZ 42. The speed and period of rotation of the RFS 40 are controlled by a rotational mechanism 70 that includes a motor 71 and a controller 72 and a rotating support 73.

The novelty of the present invention consists of a device comprising: (i) a RFS 40 with three initial reservoirs 41a, 41b and 41c, a final reservoir 44, channels 45, and at least, one DZ 42 containing a DS 43 that includes a diffraction grating for SPR detection; (ii) a set of light emitter 20 and light detector 30 arranged in such a way that the light beam is incident at the DZ 42 of the RFS 40 in a range of incident angles where the SPR effect occurs and reflected to the detector (iii) a rotational mechanism 70 that includes a motor 71, a controller 72 and a rotating support 73, built and used in order to accomplish the following sequence of events:

### (1) Initial Positioning

The RFS 40 is rotated by the rotational mechanism 70 until reaching a predefined position where the light emitter 20 illuminates the DS 43 of the DZ 42. This positioning is performed at sufficiently slow rotational velocities so that the fluid does not move from its position at the initial reservoir 41. For that, the positioning must obey the model described by equation (2).

### (2) Initial Measurement.

The light detector 30 detects the light coming from the DS 43 of the DZ 42 and a reference signal is measured. This reference signal corresponds, for example, to the DS 43 comprising a specific antibody of a certain substance to be measured.

### (3) Displacement of the First Fluid

The RFS 40 is rotated by controlling the rotational mechanism 70 at a sufficiently high rotational velocity (ω>ω_{ca}) in order to break the energy barrier existing between the channel 45 and the valve 50a, but with an rotational velocity lower than the second threshold (ω<ω_{cb}), according to the model described in equation (2). In this case, the fluid a is displaced from the initial reservoir 41a to the DZ 42.

### (4) Displacement of the Second Fluid

The RFS 40 is rotated by controlling the rotational mechanism 70 at a sufficiently high rotational velocity (ω>ω_{cb}) in order to break the energy barrier existing between the channel 45 and the valve 50b, but with an rotational velocity lower than the third threshold (ω<ω_{cc}), according to the model described in equation (2). In this case, the fluid b is displaced from the initial reservoir 41b to the DZ 42 and pushes fluid a to the final reservoir. This displacement of fluid b can allow the occurrence of the desired chemical and/or biological event (e.g. if the DS 43 comprises a specific antibody of a certain substance to be measured, and if this substance is present in the fluid, then certain amount of the substance will be captured at the DS 43). It could be convenient that the fluid remains in DZ 42 during a period of time sufficiently long (incubation period) so that the desired the chemical or biological events occur in a significant level. The optimization of the SPR sensor 10 performance depends on the type of substance to be detected, on its concentration in the fluid and also it is dependent on the properties of the DZ 42 (e.g. geometry and dimensions).

### (5) Displacement of the Third Fluid

After the desired occurrence of the chemical and/or biological events that are subject to detection, the RFS 40 is controlled by the rotational mechanism 70, in order to move the fluid c from its initial reservoir 41c to the DZ 42 pushing fluid b to the final reservoir. The rotational velocity and rotation period of the RFS 40 are controlled in such a way that the energy barrier defined by the valve 50c is passed.

### (6) Final Positioning.

The RFS 40 is rotated by the rotational mechanism 70 until it reaches a position where the light emitter 20 illuminates the DS 43 of the DZ 42 coinciding with the position of the initial measurement. The rotational mechanism 70 must be sufficiently precise in order to have a negligible positioning error (with respect to the initial SPR signal measure). This aspect is particularly important for the final behaviour of the SPR sensor 10, since it is only possible to establish a precise detection if the initial and final measurements are carried over the same surface or over surfaces with identical properties.

### (7) Final Measurement.

The light detector 30 captures the light reflected from the DS 43 of the DZ 42 and a final measure signal is obtained. This signal corresponds, for example, to the DS 43 comprising a specific antibody of a certain substance that is to be measured with a specific concentration of these chemical and/or biological substances captured by the antibodies.

### (8) Concentration Determination

The difference between the final measurement and the initial measurement allows, after having a relationship previously established by calibration, to determine the concentration in the surface of the chemical and/or biological element that has been captured at the surface. This surface concentration may then be extrapolated to a concentration in the fluid.

This example may be further generalized for an SPR sensor 10 with other sets of fluids (e.g. more than three fluids), having its functionality limited only by the correct separation of the different rotational velocity thresholds.

### Third Example

The previous examples demonstrate the fact that the present invention may be used to build and operate a SPR sensor 10 that does not require the use of external pumping and fluid control elements but where the fluid flow is unidirectional (it is not possible to make the fluids return to their initial reservoirs). In some practical cases this fact is a limiting factor for the performance of the SPR sensor 10. In particular, if the substance to be detected is present in one of the fluids at a low concentration then it would e preferable to have that fluid passing several times on the DZ 42.

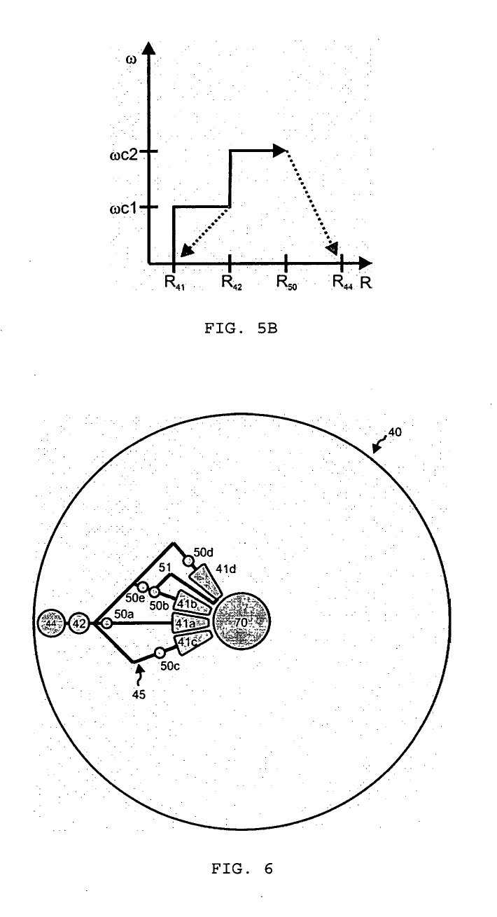

FIG. 5A shows a schematic top view of the RFS 40 of an SPR sensor 10 according to the present invention that enables the fluid passing several times on the DZ 42. The geometric dimensions of the different elements of RFS 40 are defined in such a way that the channels 45 and the DZ 42 present a combined volume smaller than the total fluid volume. In this case, the fluid will never be confined to these elements of the RFS 40 only. The surface tensions of the different elements of the RFS 40 are adjusted by construction in such a way that γ₄₁=γ₄₄=γ₄₅<γ₄₂<γ₅₀ and γ₄₂/r₄₂<γ₅₀/r₅₀. The initial reservoir 41 is connected to the DZ 42 and from here to the final reservoir 44 by the channels 45.

FIG. 5B illustrates the behaviour of the flow of an aqueous fluid in a RFS 40 represented in the FIG. 5A. Initially, the fluid is placed at the initial reservoir 41. Since γ41=γ45<γ42, the fluid fills the channels 45 but does not advance into the DZ 42. When increasing the rotational velocity of the RFS 40 and reaching the threshold ω_{c1}, the energy barrier created by the rapid variation of geometry and surface tension at the entrance of DZ 42 is exceeded and the fluid flows into the DZ 42, not advancing in the valve 50 since if the rotational velocity is smaller than its respective threshold (ω<ω_{c2}). If the rotational velocity is maintained at its value above ω_{c1} and below ω_{c2} then the fluid remains in the DZ 42. If the RFS 40 is stopped, then the fluid returns by capillarity to its initial reservoir 41 due to the difference in the pressure contribution of the two fluid fronts as a consequence of the differences in surface tension and geometry). This cycle can be repeated indefinitely. If now the RFS 40 is rotated above the rotational velocity threshold ω_{c2}, then the energy barrier defined by the valve 50 is surpassed and the fluid will flow to the final reservoir 44. Since the surface tension of this element is lower than the surface tension of the valve 50 and the DZ 42, the fluid will remain in the final reservoir 44, independently of the rotational velocity.

The novelty of the present invention consists on a device comprising: (i) a RFS 40 with an initial reservoir 41, final reservoir 44, channels 45, and at least, one DZ 42 containing a DS 43 that includes a diffraction grating for SPR detection; (ii) a set of light emitter 20 and light detector 30 arranged in such a way that the light beam is incident at the DZ 42 of the RFS 40 in a range of incident angles where the SPR effect occurs and reflected to the detector (iii) a rotational mechanism 70 that includes a motor 71 and a controller 72 and a rotating support 73, built and used in order to accomplish the following sequence of events:

### (1) Initial Positioning

The RFS 40 is rotated by the rotational mechanism 70 until reaching a predefined position where the light emitter 20 illuminates the DS 43 of the DZ 42. This positioning is performed at sufficiently slow rotational velocities so that the fluid does not move from its position at the initial reservoir 41. For that, the positioning must obey the model described by equation (2).

### (2) Initial Measurement.

The light detector 30 detects the light coming from the DS 43 of the DZ 42 and a reference signal is measured. This reference signal corresponds, for example, to the DS 43 comprising a specific antibody of a certain substance to be measured, being the DZ 42 filled with a first fluid (e.g. filled with a reference fluid)

### (3) Cycle of Forward-Reverse of Fluid Displacement

The RFS 40 is rotated by controlling the rotational mechanism 70 at a sufficiently high rotational velocity (ω>ω_{c1}) in order to break the energy barrier existing between the channel 45 and the DZ 42, but with a rotational velocity lower that the second threshold (ω<ω_{c2}), according to the model described in equation (2). In this case, the fluid is displaced from the initial reservoir 41 to the DZ 42. The RFS 40 may be a kept at an rotational velocity below ω_{c2} during a certain period of time (incubation time) in order to favour the occurrence of the chemical and/or biological event to be measured. After this period of time, the RFS 40 is stopped and the fluid returns to its initial reservoir 41 by capillary, since γ42>γ45=γ41. After this, the RFS 40 may again be rotated and the cycle may be repeated a number of times considered necessary in order to maximize the amount of captured chemicals or biological substances and hence increase the performance of the SPR sensor 10.

### (4) Displacement of the Fluid to the Final Reservoir

After the desired occurrence of the chemical and/or biological events that are subject to detection, the RFS 40 is controlled by the rotational mechanism 70, in order to move the fluid to the final reservoir 44. The rotational velocity of the RFS 40 must be sufficiently high in order to break the energy barrier defined by valve 50 (ω>ω_{c2}). Since γ50>γ45=γ44, the fluid will then stay in the final reservoir independently of the rotational velocity of the RFS 40.

### (5) Final Positioning.

The RFS 40 is rotated by the rotational mechanism 70 until it reaches a position where the light emitter 20 illuminates the DS 43 of the DZ 42 coinciding with the position of the initial measurement. The rotational mechanism 70 must be sufficiently precise in order to have a negligible positioning error (with respect to the initial SPR signal measure). This aspect is particularly important for the final behaviour of the SPR sensor 10, since it is only possible to establish a precise detection if the initial and final measurements are carried over the same surface or over surfaces with identical properties.

### (6) Final Measurement.

The light detector 30 captures the light reflected from the DS 43 of the DZ 42 and a final measure signal is obtained. This signal corresponds, for example, to the DS 43 comprising a specific antibody of a certain substance that is to be measured with a specific concentration of these chemical and/or biological substances captured by the antibodies.

### (7) Concentration Determination

The difference between the final measurement and the initial measurement allows, after having a relationship previously established by calibration, to determine the concentration in the surface of the chemical and/or biological element that has been captured at the surface. This surface concentration may then be extrapolated to a concentration in the fluid.

The Combination of the method and system described in this example with the SPR detection of chemical and/or biological events allows the man of the art, to build multi-functional detection equipment. For example, through the sequential detection of the variations on the SPR signal from an initial step when the DS 43 is found virgin, through the process of chemical or biological probe immobilization at this surface to the capture of the desired substances by these immobilized probes. The description of this example is still valid for different geometries, dimensions and surface tension values of the RFS 40, as long as (according to the model described by equation (2)), it guarantees the existence of rotational velocity thresholds that are well defined so that the system behaves according to the description of FIG. 5B.

### Fourth Example

In the previous examples, we have described some basic functions that are usually necessary in a detection device. In the first example we have demonstrated the use of the present invention for the detection (by SPR in the grating configuration) of chemical and/or biological substances without the use of external fluidic elements (pumps, tubes, etc). In reality, other elements are also necessary for a more universal SPR sensor: (i) a physical support that enables the accomplishment of different actions (in this case meaning the fluid flow from point A to point B, SPR measurement in point C); (ii) the possibility of realizing cyclic and conditional functions.

The first example of the present invention demonstrated the basic function of a SPR detection device without the use of external fluidic elements. In the second example, a more complex concretization was presented, allowing the sequential flow of fluids for SPR detection. In the third example the cyclic function of fluid flow and control was presented (while condition A is not verified, do the cycle of actions B, meaning in the above example, to push the fluid from the initial reservoir 41 into the DZ 42 and after a certain period, return of the fluid to the initial reservoir 41, and repeat this action until the threshold rotational velocity of valve 50 is not exceeded. In this fourth example we describe the realization of a conditional function to be used, according to the present invention, in the SPR sensor 10.

FIG. 6 shows a schematic horizontal view of the RFS 40 of an SPR sensor 10 according to the present invention, enabling the SPR detection of one of two fluids, depending on the result of a first measurement. The geometric dimensions of the different elements of RFS 40 are defined in such a way that the channels 45 and DZ 42 contain a volume smaller than the total fluid volume, so the fluid is never confined to these elements only. The RFS 40 contains four reservoirs and three fluids (fluid a in reservoir 41a, fluid b in reservoir 41b, fluid c in reservoir 41c, and a fourth reservoir 41d which is empty). The valves 50a, 50b, 50c, 50d and 50e are constructed in such a way that, according to equation (2), the rotational velocity thresholds are ωca<ωcb<ωcc<ωce<ωcd. By construction, the return channel 51 and the reservoir 41d have a lower surface tension when compared to the other channels 45 and the reservoir 41b. Thus, if the RFS 40 is rotated at an rotational velocity ωca then fluid a is directed to the DZ 42. Depending on the result of the SPR measurement on fluid a, it is possible to perform the next SPR measure on either fluid b or fluid c, depending on one of the actions: (i) the RFS 40 is rotated at a rotational velocity ωce and fluid b passes the valve 50b and the valve 50e and fills the DZ 42; (ii) the RFS 40 is rotated at a rotational velocity ωcb and fluid b arrives to the entrance of the valve 50e. If the rotational velocity is lower than ωce and then the RFS 40 is stopped, then fluid b will move by capillarity into the reservoir 41d. If now the RFS 40 is rotated at the rotational velocity ωcc then the fluid c will pass the valve 50c and arrive to the DZ 42.

The novelty of the present invention consists of a device comprising: (i) a RFS 40 with four initial reservoirs 41a, 41b, 41c and 41d, final reservoir 44, valves 50a, 50b, 50c, 50d, and 50e, channels 45, and at least, one DZ 42 containing a DS 43 that includes a diffraction grating for SPR detection; (ii) a set of light emitter 20 and light detector 30 arranged in such a way that the light beam is incident at the DZ 42 of the RFS 40 in a range of incident angles where the SPR effect occurs and reflected to the detector (iii) a rotational mechanism 70 that includes a motor 71, a controller 72 and a rotating support 73, built and used in order to accomplish the following sequence of events:

### (1) Displacement of the First Fluid

The RFS 40 is rotated by controlling the rotational mechanism 70 at a sufficiently high rotational velocity (ω>ωca) in order to break the energy barrier existing between channel 45 and valve 50a, but with an rotational velocity lower that the second threshold (ω<ωcb), according to the model described by equation (2). In this case, fluid a is displaced from the initial reservoir 41a to the DZ 42.

### (2) Positioning

The RFS 40 is rotated by the rotational mechanism 70 until reaching a predefined position where the light emitter 20 illuminates the DS 43 of the DZ 42. This positioning is performed at sufficiently slow rotational velocities so that the fluid does not move from its position at the initial reservoir 41. For that, the positioning must obey the model described by equation (2).

### (3) Initial Measurement.

The light detector 30 detects the light coming from the DS 43 of the DZ 42 and a reference signal is measured. This reference signal corresponds, for example, to the DS 43 comprising a specific antibody of a certain substance to be measured, being the DZ 42 filled with a first fluid

### (4) Data Treatment and Decision on the Next Fluid

Depending on the result of the initial measurement, the second fluid to pass on the DZ 42 is chosen. This can either be fluid b as explained below in points 5a) and 6a) or fluid c as explained below in points 5b) and 6b)

### (5a) Displacement of Fluid b

The RFS 40 is rotated by controlling the rotational mechanism 70 at a sufficiently high rotational velocity (ω>ωce) in order to break the energy barrier existing between channel 45 and valves 50b and 50e, but with a rotational velocity lower than the threshold for fluid c (ωcc). In this case, fluid b will move from its initial reservoir 41b to the DZ 42. The RFS 40 may be kept at an rotational velocity below ωcc during a desired period of time in order to favour the occurrence of the chemical and/or biological event to be measured. After this period of time, the RFS 40 is stopped.

### (6a) Final Measurement of Fluid b

After the desired occurrence of the chemical and/or biological events that are subject to detection the RFS 40 is rotated by the rotational mechanism 70 until it reaches a position where the light emitter 20 illuminates the DS 43 of the DZ 42 coinciding with the position of the initial measurement. The rotational mechanism 70 must be sufficiently precise in order to have a negligible positioning error of the RFS 40. The light detector 30 captures the light reflected from the DS 43 of the DZ 42 and a final measure signal is obtained. This signal corresponds, for example, to the DS 43 comprising a specific antibody of a certain substance that is to be measured with a specific concentration of these chemical and/or biological substances captured by the antibodies.

### (5b) Displacement of the Fluid c

The RFS 40 is rotated by controlling the rotational mechanism 70 at a sufficiently high rotational velocity (ω>ωcb) in order to break the energy barrier existing between channel 45 and valve 50b but nevertheless lower than the next threshold ωce. In this case, fluid b will move from its initial reservoir 41b to the entrance of the valve 50e. Then the RFS 40 is stopped and fluid b will flow by capillary into reservoir 41d. After a certain period of time that allows for fluid b filling reservoir 41d, the RFS 40 is again rotated at a sufficiently high rotational velocity (ω>ωcc) in order to break the energy barrier existing between the channel 45 and the valve 50c but with a rotational velocity lower than the next threshold ωcd. In this case, fluid c will move from its initial reservoir 41c to the DZ 42. The RFS 40 may be kept at an rotational velocity below ωcd during a desired period of time (incubation time) in order to favour the occurrence of the chemical and/or biological events to be measured. After this period of time, the RFS 40 is stopped.

### (6b) Final Measurement of Fluid c

After the desired occurrence of the chemical and/or biological events that are subject to detection the RFS 40 is rotated by the rotational mechanism 70 until it reaches a position where the light emitter 20 illuminates the DS 43 of the DZ 42 coinciding with the position of the initial measurement. The rotational mechanism 70 must be sufficiently precise in order to have a negligible positioning error of the RFS 40. The light detector 30 captures the light reflected from the DS 43 of the DZ 42 and a final measure signal is obtained. This signal corresponds, for example, to the DS 43 comprising a specific antibody of a certain substance that is to be measured with a specific concentration of these chemical and/or biological substances captured by the antibodies.

The configuration of the SPR sensor 10 described in this example may be considered advantageous, for example, in the cases where SPR sensor 10 presents a detection limit affected by the concentration of the substance to be measured (e.g. it is only able to quantify low substance concentrations and saturates at higher substance concentrations). In this case, the man of the art may build a detection device that enables the tuning of dilution of the original fluid (e.g. from a patient's blood) in order to have a proper dilution ratio that fits within the detection range of the SPR sensor 10 itself. Moreover, there are other cases where the relevant range is still superior to the detection limits (upper and lower) and where a single dilution is insufficient for proper performance of the SPR sensor 10. In these later cases, the present invention may be used in order to build a SPR sensor 10 with all the relevant range if different dilutions are used in reservoirs 41a, 41b and 41c or using additional dilution reservoirs.

### Fifth Example

Beyond the previously described examples, it may also be considered with advantage to have a device with multiple detection zones. These DZ 42 may be used, for example, to measure multiple chemical elements or biological substances from the same fluid sample volume. This new configuration may be achieved extrapolating the configurations described in the previous examples, by introducing multiple DZ 42 between the initial and final reservoirs. This new configuration however, may still be considered limited to a certain number of elements. In order to overcome these limitations, we now describe a fluidic system that enables to control flow using bifurcations and applying the principles described in the previous example.

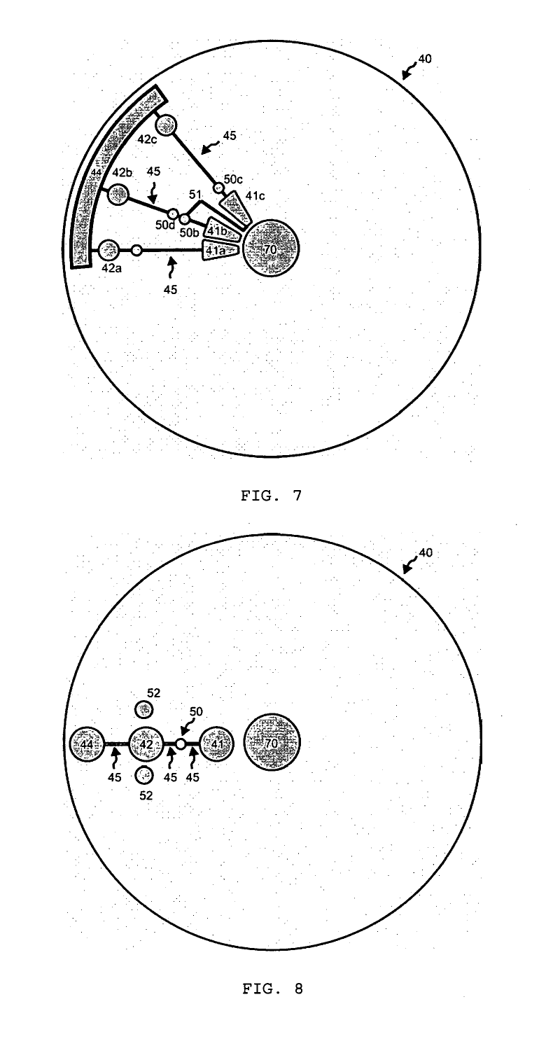

FIG. 7 shows a schematic top view of the RFS of an SPR sensor according to the present invention, allowing SPR detection in one of two DZ 42b and 42c, depending on an initial measurement on DZ 42a. The geometric parameters and the surface tension of the fluidic elements (reservoirs, valves and DZ) are defined in such a way that the channels 45 and the DZ have a volume smaller than the total fluid volume, so that the fluid is never confined to these elements only. The RFS 40 contains three reservoirs and two fluids (fluid a in the reservoir 41a, fluid b in the reservoir 41b, and a third reservoir 41c which is empty). The valves 50a, 50b, 50c and 50d are built in a way that, according to equation (2), the rotational velocity thresholds follow the relation ωca<ωcb<ωcc<ωcd. By construction, the return channel 51 and the reservoir 41c have a lower surface tension compared to the other channels 45 and the reservoir 41b. Thus, if the RFS 40 is rotated at an rotational velocity ωca then fluid a is directed to the DZ 42a. Depending on the result of the SPR measurement on fluid a, it is possible to perform the next SPR measurement on either DZ 42b or 42c, depending on one of the following actions: (i) the RFS 40 is rotated at an rotational velocity ωcd and the fluid b passes both valves 50b and 50d and fills the DZ 42b; (ii) the RFS 40 is rotated at an rotational velocity ωcb and the fluid b arrives to the entrance of the valve 50d. If the rotational velocity is lower than ωcd and then the RFS 40 is stopped, then fluid b will move by capillary into reservoir 41c. If now the RFS 40 is rotated at an rotational velocity ωcc then the fluid b will pass the valve 50c and arrive to the DZ 42c.

The novelty of the present invention consists of a device comprising: (i) a RFS 40 with initial reservoirs 41a, b and c, final reservoir 44, valves 50 a, b, c and d, channels 45, and at least, three DZ 42a, 42b and 42c containing each a DS 43 that includes a diffraction grating allowing for SPR detection; (ii) a set of light emitter 20 and light detector 30 arranged in such a way that the light beam is incident at one of the DZ 42 of the RFS 40 in a range of incident angles where the SPR effect occurs and reflected to the detector (iii) a rotational mechanism 70 that includes a motor 71, a controller 72 and a rotating support 73, built and used in order to accomplish the following sequence of events:

### (1) Displacement of the First Fluid

The RFS 40 is rotated by controlling the rotational mechanism 70 at a sufficiently high rotational velocity (ω>ωca) in order to break the energy barrier existing between channel 45 and valve 50a, but with an rotational velocity lower that the second threshold value (ω<ωcb), according to the model described by equation (2). In this case, fluid a is displaced from the initial reservoir 41a to the DZ 42.

### (2) Positioning

The RFS 40 is rotated by the rotational mechanism 70 until reaching a predefined position where the light emitter 20 illuminates the DS 43 of the DZ 42a. This positioning is performed at sufficiently slow rotational velocities so that the fluid does not move from its position at the initial reservoir 41a. For that, the positioning must obey the model described by equation (2).

### (3) Initial Measurement.

The light detector 30 detects the light coming from the DS 43 of the DZ 42a and a reference signal is measured. This reference signal corresponds, for example, to the DS 43 comprising a specific antibody of a certain substance to be measured, being the DZ 42a filled with the first fluid (fluid a)

### (4) Data Treatment and Decision on the Next DZ

Depending on the result of the initial measurement, the second detection zone DZ 42b or DZ 42c can be alternatively chosen as explained below in points 5a) and 6a) or 5b) and 6b), respectively.

### (5a) Displacement of the Fluid to the DZ 42b

The RFS 40 is rotated by controlling the rotational mechanism 70 at a sufficiently high rotational velocity (ω>ωce) in order to break the energy barrier existing between channel 45 and valves 50b and 50d. In this case, the fluid will move from its initial reservoir 41b to the DZ 42b. The RFS 40 may be kept at this rotational velocity during the desired period of time in order to favour the occurrence of the chemical and/or biological event to be measured. After this period of time, the RFS 40 is stopped.

### (6a) Final Measurement of the Fluid in the DZ 42b

After the desired occurrence of the chemical and/or biological events that are subject to detection the RFS 40 is rotated by the rotational mechanism 70 until it reaches a position where the light emitter 20 illuminates the DS 43 of the DZ 42b coinciding with the position of the initial measurement. The rotational mechanism 70 must be sufficiently precise in order to have a negligible positioning error of the RFS 40. The light detector 30 captures the light reflected from the DS 43 of the DZ 42b and a final measure signal is obtained. This signal corresponds, for example, to the DS 43 comprising a specific antibody of a certain substance that is to be measured with a specific concentration of these chemical and/or biological substances captured by the antibodies.

### (5b) Displacement of the Fluid to the DZ 42c

The RFS 40 is rotated by controlling the rotational mechanism 70 at a sufficiently high rotational velocity (ω>ωcb) in order to break the energy barrier existing between channel 45 and valve 50b but nevertheless lower than the threshold value ωcd. In this case, the fluid will move from its initial reservoir 41b to the entrance of the valve 50d. Then the RFS 40 is stopped and fluid b will flow by capillary into the reservoir 41c. After a certain period of time that allows fluid b to fill the reservoir 41c, the RFS 40 is again rotated at a sufficiently high rotational velocity (ω>ωcc) in order to break the energy barrier existing between channel 45 and valve 50c and hence displace the fluid from reservoir 41c to DZ 42c. The RFS 40 may be kept at an adequate rotational velocity during a desired period of time in order to favour the occurrence of the chemical and/or biological event to be measured. After this period of time, the RFS 40 is stopped.

### (6b) Final Measurement of the Fluid in the DZ 42c

After the desired occurrence of the chemical and/or biological events that are subject to detection the RFS 40 is rotated by the rotational mechanism 70 until it reaches a position where the light emitter 20 illuminates the DS 43 of the DZ 42c coinciding with the position of the initial measurement. The rotational mechanism 70 must be sufficiently precise in order to have a negligible positioning error of the RFS 40. The light detector 30 captures the light reflected from the DS 43 of the DZ 42c and a final measure signal is obtained. This signal corresponds, for example, to the DS 43 comprising a specific antibody of a certain substance that is to be measured with a specific concentration of these chemical and/or biological substances captured by the antibodies.

### Sixth Example

Beyond the above-mentioned examples of the present invention, it may be considered favourable to include an auxiliary DZ 52 also based on the SPR effect as schematically shown in FIG. 8 (for example, in order to measure a reference signal whose variation with temperature is known). This may be used in order to optimize the overall performance of the device used for SPR detection of chemical and/or biological events.

The optical detection based on the SPR effect is extremely sensitive to temperature changes in the system where the DS 43 is placed. In particular, the proper measurement of the detection temperature usually implies, in conventional devices, the use of additional electronic elements (temperature sensors, ADC modules and acquisition systems). These additional elements represent a greater increase in complexity and also an increase the detection system cost. This limitation may be surpassed creating auxiliary detection zones 52 and exploiting again the SPR effect in the neighbourhood of DZ 42. This accomplishment is illustrated in FIG. 8. The auxiliary detection zones 52 are closed chambers containing a fluid, or polymer or gas with known refractive index. Therefore the SPR sensor 10 may be built and used in order to simultaneously detect the concentration of chemical and/or biological elements present in the DZ 42 and the detection temperature (next to the DZ). On the other hand, if the measurement temperature is determined with sufficient precision and if the device includes the information of the relevant calibration of signal SPR in the DZ 42 as a function of the concentration of the chemical and/or biological element to be measured, then it is possible to build a SPR sensor 10 in such a way that its temperature control is simplified and in consequence, of a lower cost.

FIG. 8 shows a schematic top view of the RFS 40 of an SPR sensor 10 according to the present invention, with the basic elements used for the detection tasks (initial reservoir 41, DZ 42, final reservoir 44, channels 45). The RFS 40 also include auxiliary detection zones 52 in the close proximity of the DZ 42. The auxiliary detection zones 52 are properly confined and contain a fluid with known optical properties, in particular, the refractive index dependence on temperature. In this configuration, detection through the SPR effect not only allows the determination of the occurrence of chemical events and/or biological in 42 DZ but also the determination with precision of the temperature at the auxiliary detection zones 52, and by extrapolation, the determination of the temperature at DZ 42. This complementary determination, although not essential for SPR sensor 10 performance in accordance with the present invention, is considered favourable since it allows the minimization of noise effects induced by local temperature oscillations at the DZ 42. Having this complementary measurement, one may optimize the signal to noise ratio, and consequently optimize the SPR sensor 10 performance, namely in terms of its detection limit.

### Seventh Example

Most of the systems described in the previous examples were based on a RFS 40 having its elements (channels 45, reservoirs 41 and 44, valves 50 and DZ 42) with different geometric parameters, namely in terms of their hydraulic diameters. In particular, the previous examples have presented mostly a binary change of the hydrophilic or hydrophobic nature of the different elements of the RFS 40. The man of the art may further exploit this surface tension effect by properly adjusting the surface properties of each element, in particular by properly controlling the surface tension of each element of the RFS 40. According to equation (2), the adjustment of the superficial tension may allow, for example, for a complementary tuning after setting the geometrical parameters in order to better separate the rotational velocity thresholds. Or, in a limit-case, the RFS 40 may be considered to have all its elements with the same geometric properties (and so, having all elements the same hydraulic diameter), and only having a dominant parameter defined by the surface tension of each individual element of the RFS 40.

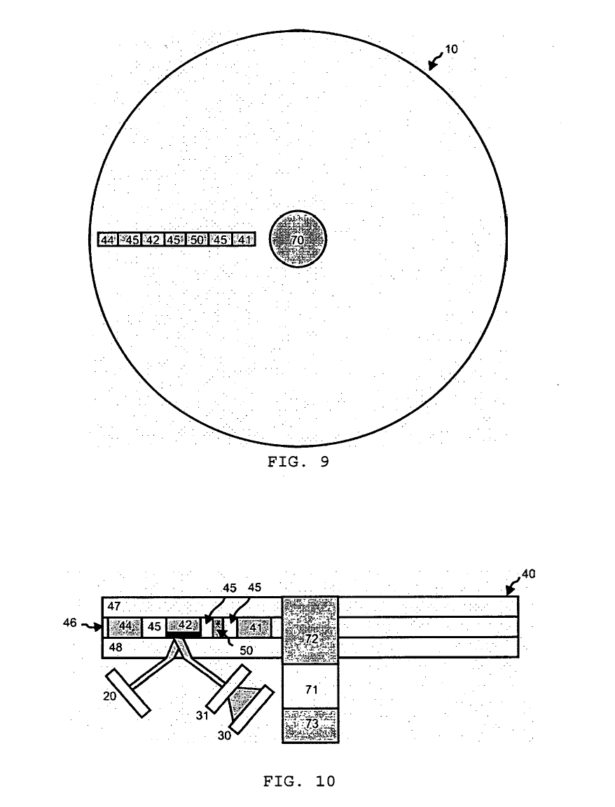

FIG. 9 shows a schematic top view of the RFS 40 of an SPR sensor 10 according to the present invention, wherein the geometrical dimensions of the different fluidic elements (reservoirs 41 and 44, valves 50 and DZ 42) are kept constant and only their surface tension is controlled. In this case, the variation of the superficial tension of each element of the RFS 40 is adjusted in such a way to compensate the respective difference of radial position. In accordance with the illustrated description, for an aqueous fluid, if γ45/r45<γ50/r50<γ42/r42 then the DZ 42 and the valve 50 will act as energy barriers for the free fluid flow. The system will then present the same behaviour already described in FIG. 3A, 3B or 3C.

### Eight Example

The systems described in the previous examples of the present invention may also be materialized without disadvantage if the optical measurements by the light detector 30 are performed in terms of light intensity as a function of light wavelength (compared to the mentioned configuration of light intensity as a function of incident angle). In this case, and according to FIG. 10, the light emitter 20 of the SPR sensor 10 will have to emit a polychromatic beam into the DS 43 of the DZ 42, and between this and the light detector 30 one should place a spectral splitter element 31 (e.g. a prism).

### Ninth Example

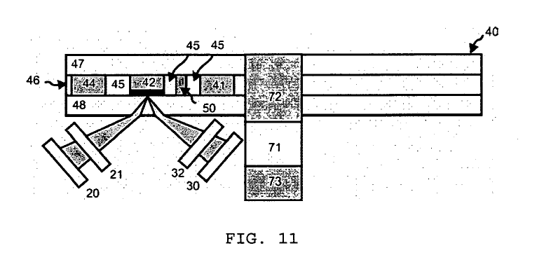

The systems described in the previous examples of the present invention may also be materialized without disadvantage if the optical measurements by the light detector 30 are performed in terms of light phase change as a function of the incident angle. In this case, and according to FIG. 11, the light emitter 20 of the SPR sensor 10 may include a phase compensator 21 (e.g. quarter-wave birefringent plate) and a detection polarizer 32 may be used between the RFS 40 and the light detector 30. These two last elements (the phase compensator 21 and the detection polarizer 32) may be placed at different positions of the SPR sensor 10 without disadvantage (e.g., the phase compensator 21 can be placed immediately before the detection polarizer 32).

The previous examples describe devices wherein the measurement of the SPR signal is performed when having stopped the rotation of the RFS (40). In some cases, the present invention may also be materialized without disadvantage if the optical measurements are performed while having the RFS (40) in rotation (e.g. in order to have the dynamic measurement of the chemical and/or biological events). In this case, the positioning components may be complemented or even replaced by a triggering component for the light emitter (20) and/or the light detector (30). These examples demonstrate that the present invention may be used in order to build and operate a SPR sensor 10, that exploits the SPR effect in the grating configuration in order to detect chemical and/or biological events and simultaneously does not require the use of additional external fluidic elements in order to properly control the fluid flow, in opposition to conventional sensors.

### SUMMARY OF THE ABBREVIATIONS

SPR Sensor 10
   Light Emitter 20
      Phase compensator 21
   Light Detector 30
      Spectral Splitter 31
      Detection Polarizer 32
   Rotational Fluidic Substrate RFS 40
      Initial Reservoir 41
      Detection zone DZ 42
      Detection Surface DS 43
      Final Reservoir 44
      Channels 45
      Confinement Spacers 46
      Cover 47
      Substrate 48
      Pressure-Equilibrium channel 49
      Valve 50
      Return Channel 51
      Auxiliary Detection Zone 52
   External fluidic elements 60
      Tubes 61
      Pumping system 62
      Fluid Reservoirs 63
      Fluid Selection mechanism 64
      Final reservoirs 65
   Rotational Mechanism 70
      Motor 71
      Controller 72
      Rotational support 73

1. A detection device comprising:
(i) a light emitter (20) and a light detector (30);
(ii) a Rotational Fluidic Substrate (RFS) (40);
(iii) geometric and/or surface tension arrangements in the channels (45), initial reservoirs (41) and Detection Zone (DZ) (42);
(iv) a control means (70) used to control the period and rotational velocity of the RFS (40);
characterized in that
a) the RFS (40) includes channels (45) that connect at least one initial reservoir (41) to a DZ (42), in which is positioned a Detection Surface (DS) (43) including a thin conductive layer, defining in its surface a diffraction grating;
b) the geometric and/or surface tension arrangements in the channels (45), initial reservoir (41) and DZ (42) are arranged in such a way that they define the existence of a barrier preventing the free flow of fluid from the initial reservoir (41) to the DZ (42), wherein that barrier can be surpassed through the increase of the rotational velocity of the RFS (40);
c) the device enables the measurement, by means of the Surface Plasmon Resonance effect created in the proximity of the diffraction grating in the DZ (42), of the chemical and/or biological events occurring in the close proximity of the grating DS (43) of the DZ (42);
d) the device is able to channel the flow of at least one fluid from a initial reservoir (41) to a DZ (42).

2. The detection device of claim 1, characterized in that the RFS (40) includes channels (45) that connect at least two initial reservoirs (41) and one DZ (42) including a DS (43), the device enabling the sequential control of flow of at least two fluids from their initial reservoirs (41) into the DZ (42) by controlling their rotation;

3. The detection device of claim 1 or claim 2, characterized in that the said geometric and/or surface tension arrangements in the channels (45), initial reservoirs (41) and DZ (42) of the RFS (40) are arranged in such a way that they define the existence of at least two barriers preventing the free flow of the fluids from their initial reservoirs (41) to the DZ (42), and wherein such barriers can be surpassed through the increase of the rotational velocity of the RFS (40).

4. The detection device of claim 2 or claim 3, characterized in that the said RFS 40 includes at least one final reservoir (44), in that the geometric and/or surface tension arrangements in the channels (45), initial reservoirs (41) and final reservoir (44) DZ (42) are arranged in such a way that, after rotating the RFS (40) for velocities below a critical threshold at least one fluid returns from the DZ (42) to the initial reservoir (41), and in that the said geometric and/or surface tension arrangements are arranged in such a way that, after rotating the RFS (40) for velocities above a preset critical threshold, the fluids do not return to their initial reservoirs (41).

5. The detection device of any one of previous claims characterized in that the RFS (40) includes channels (45) that connect, at least three initial reservoirs (41) to a DZ (42) and a final reservoir (44), in that the device enables by controlling the velocity, the selection of the sequence of fluids that flow from their initial reservoirs (41) to at least one DZ (42).

6. The detection device of any one of previous claims characterized in that the said RFS (40) includes channels (45) that connect, at least two initial reservoirs (41), one fluid and a final reservoir (44) and two DZ (42), in that the said geometric and/or surface tension arrangements are formed in such a way that there are at least three rotational frequency thresholds that prevent the free flow of the fluids from their initial reservoirs (41) into the DZ (42), and in that the device enables, through the control of the rotation, the selection of the DZ (42) for which at least one fluid is to be directed.

7. The detection device of any one of previous claims characterized in that the RFS (40) further includes at least one auxiliary detection zone (52) containing a fluid or polymer of known properties, a rotational mechanism (70) enabling the positioning of the RFS (40) with respect to the light emitter (20) and the light detector (30), and in that it enables through measurement of the Surface Plasmon resonance effect on the auxiliary detection zone (52) the determination of additional properties of the chemical and/or biological system under analysis.

8. The detection device of claims 1-5 characterized in that only the said surface tension values of the said channels (45), initial reservoirs (41), final reservoirs (44) and DZ (42) define the existence of barriers preventing the free flow of the fluids from said initial reservoirs (41) to said DZ (42), wherein said barriers can be surpassed through the increase of said rotational velocity of said the said RFS (40).

9. The detection device of claims 1-8 characterized in that the said light radiation emitted from the light emitter (42) passes through the fluid in order to be incident at the said DS (43) containing a thin electrically conductive layer defining in its surface a diffraction grating.

10. The detection device of claims 1-8 characterized in that the said light radiation emitted from the light emitter (42) passes through the substrate (48) of the RFS (40) in order to be incident at the said DS (43) containing a thin electrically conductive layer defining in its surface a diffraction grating, not crossing the optical path of any fluid.

11. The detection device of claims 1-10 characterized in that the detection of the Surface Plasmon Resonance effect is obtained through the measurement of the radiation intensity of the light transmitted, reflected or diffracted from the said DS (43) containing a thin conductive layer its surface defining a diffraction grating, as a function of the incident angle of the light radiation onto the said DS (43).

12. The detection device of claims 1-10 characterized in that the detection of the Surface Plasmon Resonance effect is obtained through the measurement of the radiation intensity of the light, transmitted, reflected or diffracted from the said DS (43) containing a thin conductive layer its surface defining a diffraction grating, as a function of the light radiation wavelength incident onto the said DS (43).

13. The detection device of claims 1-10 characterized in that the detection of the Surface Plasmon Resonance effect is obtained through the measurement of the radiation intensity of the light transmitted, reflected or diffracted from the said DS (43) containing a thin conductive layer its surface defining a diffraction grating, as a function of the phase of the light radiation incident onto the said DS (43).

14. The detection device of any of previous claims characterized in that the said RFS (40) consists on two flat substrates, containing at least at one of their surfaces at least one zone with a diffractive conductive layer, there being a further third substrate placed in between the two mentioned substrates, said third substrate defining the contours of the said channels (45), initial reservoirs (41), final reservoirs (44) and valves (50).
